(19) United States
(12) Patent Application Publication
(10) Pub. No.: US 2018/0195321 A1
(43) Pub. Date: Jul. 12, 2018

(54) AUTOMOBILE FUEL TANK LOCK

(71) Applicant: TRANSPACE TECHNOLOGY CHANG CHUN INC., Changchun City (CN)

(72) Inventor: Zexiu ZHANG, Changchun City (CN)

(21) Appl. No.: 15/866,214

(22) Filed: Jan. 9, 2018

(30) Foreign Application Priority Data
Jan. 10, 2017 (CN) 2017100151950

(51) Int. Cl. E05B 83/34; E05B 81/06; E05B 81/14

(52) U.S. Cl. CPC E05B 83/34; E05B 81/14; E05B 81/06

(57) ABSTRACT

The present disclosure provides an automobile fuel tank lock, comprising a manual unlocking structure that comprises: a push rod, comprising a cylindrical rod body, and a lock tongue connected to a top of the cylindrical rod body; a locating block connected to a bottom of the cylindrical rod body; a guiding ring provided at a bottom of the locating block, a top surface of the guiding ring being toothed; a guiding sleeve fixedly connected onto the base, comprising a cavity and a sidewall surrounding the cavity; the cylindrical rod body is rotatably provided in the cavity and can translate therein; a height of the locating rib is smaller than the depth of the deep guiding groove while larger than the depth of the shallow guiding groove; a spring provided on the base, and located between the locating block and the guiding ring. The present disclosure reduces the noise generated in the unlocking and locking process of the automobile fuel tank lock.

### TECHNICAL FIELD

The present disclosure relates to an automobile fuel tank lock.

### BACKGROUND ART

Currently, during the automobile travelling, the fuel tank cap will be easily automatically opened when the fuel tank unlocking key is unconsciously pressed, which causes a potential safety hazard and a damage to the fuel tank cap. The Chinese utility model patent with an application number 201420375582.7 discloses an automobile fuel tank lock, which enables the opening to be convenient, and solves the problem that the fuel tank cap is automatically opened by a misoperation. But during the use of device of the patent, the noise is loud and the environment is affected, which is detrimental to people's health.

### SUMMARY OF THE INVENTION

The present disclosure provides an automobile fuel tank lock to reduce the noise.

To this end, the present disclosure provides an automobile fuel tank lock, comprising:

a manual unlocking structure that comprises:

a push rod, comprising a cylindrical rod body, and a lock tongue connected to a top of the cylindrical rod body;

a locating block connected to a bottom of the cylindrical rod body, comprising a column and locating ribs provided on an outer side of the column; a top of each of the locating ribs is provided with a first locating rib bevel; a bottom of each of the locating ribs is provided with a second locating rib bevel; either of the first locating rib bevel and the second locating rib bevel forms an angle less than 90° with respect to a plane where a bottom edge of the column is located;

a guiding ring provided at a bottom of the locating block, a top surface of the guiding ring being toothed and provided with tooth tips and tooth roots;

the second locating rib bevel is located on the top surface of the toothed guiding ring, and slidable and rotatable relative thereto;

a base for accommodating and supporting the guiding ring;

a guiding sleeve fixedly connected onto the base, comprising a cavity and a sidewall surrounding the cavity; an inner sidewall of the guiding sleeve is provided with deep guiding grooves and shallow guiding grooves which are alternatively arranged, and a depth of the deep guiding groove is larger than a depth of the shallow guiding groove;

the cylindrical rod body is rotatably provided in the cavity and can translate therein; a height of the locating rib is smaller than the depth of the deep guiding groove while larger than the depth of the shallow guiding groove; the locating rib can slide in the deep guiding groove; and a bottom of the shallow guiding groove is provided with a bottom clamp stand for limiting the locating rib;

a spring provided on the base and located between the locating block and the guiding ring.

Further, the deep guiding groove and the shallow guiding groove are separated from each other by a rib; a bottom of the rib is provided with a connection surface which connects the deep guiding groove with the shallow guiding groove, and which is a first bevel having a first height difference; the bottom clamp stand of the shallow guiding groove has a limiting bottom surface which is a second bevel having a second height difference; a height difference between the tooth tip and the tooth root is larger than either of the first height difference and the second height difference.

Further, the push rod further comprises a first rotation guiding device located on a side of the cylindrical rod body, and the guiding sleeve is provided with a second rotation guiding device for guiding the first rotation guiding device.

Further, the base is provided with a locating rod for mounting the spring, and the spring and the guiding ring are provided to sleeve the locating rod.

Further, the deep guiding groove and the shallow guiding groove are both straight grooves vertically arranged; the number of the deep guiding grooves is three, the number of the shallow guiding grooves is three, and the number of the locating ribs is three.

Further, a lengthwise direction of the locating rib is an axial direction of the column, the first locating rib bevel and the second locating rib bevel are rectangular, and an extending direction of either of the first locating rib bevel and the second locating rib bevel is projected on a horizontal plane as a circumferential direction of the column.

Further, the automobile fuel tank lock further comprises an electric unlocking structure that comprises:

a motor;

an electric lock pin connected to the motor;

a lock pin bayonet provided on a sidewall of the guiding sleeve; the electric lock pin is movable in the lock pin bayonet, and a moving direction of the electric lock pin is perpendicular to an axial direction of the cylindrical rod body; when the electric lock pin moves into the lock pin bayonet, the electric lock pin limits a top of the column.

Further, the automobile fuel tank lock further comprises an upper cover snap-fitted with the base, and the base and the upper cover form a sealed space for mounting the motor, the electric lock pin, the push rod, the guiding ring, the locating block, the guiding sleeve and the spring.

Further, the electric unlocking structure further comprises a threaded rod connected between the motor and the electric lock pin.

Further, the first rotation guiding device is a spiral groove, and the second rotation guiding device is a guiding bump.

In the present disclosure, by pressing the lock tongue, the push rod drives the locating block to move downwards; in the pressing process, the locating rib exits the bottom of the deep guiding groove; since the top of the locating rib has the locating rib bevel and the top of the guiding ring is toothed, the top of the locating rib slides circumferentially after exiting the bottom of the deep guiding groove, thereby causing the locating block to be rotated and clamped under the bottom clamp stand of the shallow guiding groove along the connection surface of the bottom of the deep guiding groove, while cannot move upwards. Meanwhile, in this process, the side of the cylindrical rod body is provided with a first rotation guiding device through which the cylindrical rod body is rotated, and the lock tongue is rotated when being pressed to reach a stable unlocking position, thereby realizing an unlocking, otherwise a locking is realized.

In the processes of unlocking and locking, the applicant finds, after repeated researches, that the noise of the automobile fuel tank lock is mainly caused by the contact between the locating block and the guiding ring during unlocking or locking. Thus, the applicant further takes measures to reduce the hard contact between the locating block and the guiding ring while achieving the above unlocking convenience, or change the hard contact between the locating block and the guiding ring into a soft contact, i.e., provide a spring between the locating block and the guiding ring. On one hand, the spring functions to restore and support, so as to ensure a smooth unlocking and locking. On the other hand, the spring has an elastic buffering function in the processes of unlocking and locking of the automobile fuel tank lock, so that the contact between the locating block and the guiding ring is achieved through an elastic buffering, and the contact between the locating block and the guiding ring is gentler and softer, which relieves the load exceeding a pressure required for a transmission between the locating block and the guiding ring, greatly decreases the huge impact between the locating block and the guiding ring, and largely reduces the noise of the automobile fuel tank lock in the processes of unlocking and locking to below 40 db.

Further, the applicant also takes measures to limit the movement of the guiding ring, so that the guiding ring is fixed, which reduces the noise generated by the movement of the guiding ring, and further reduces the noise generated in the unlocking or locking process, so that noise generated in the unlocking or locking process is reduced to below 40 db, and the abrasion of the guiding ring is also decreased.

Further, since the spring is provided between the locating block and the guiding ring, the contact between the locating block and the guiding ring is completed by an elastic buffering and becomes gentler and softer. The spring satisfies a necessary pressure between the locating block and the guiding ring, while relieving extra load and impact exceeding the necessary pressure, which greatly reduces the abrasion between the locating block and the guiding ring. In particular, during traveling of the automobile, the spring can buffer the abrasions caused by various strenuous motions. Thus, the present disclosure prolongs the service lives of the locating block, the guiding ring, and then the automobile fuel tank lock.

### BRIEF DESCRIPTION OF THE DRAWINGS

FIG. 1 illustrates a schematic diagram of an exploded structure of a manual unlocking structure of an automobile fuel tank lock in an embodiment of the present disclosure;

FIG. 2 illustrates a schematic diagram of front-viewed structures in an embodiment of the present disclosure, before a base and an upper cover being mounted;

FIG. 3 illustrates an A-A section-viewed structure of FIG. 2;

FIG. 4 illustrates a schematic diagram of front-viewed structures in an embodiment of the present disclosure, after the base and the upper cover being mounted;

FIG. 5 illustrates a B-B section-viewed structure of FIG. 4;

FIG. 6 illustrates a schematic diagram of an exploded structure of an electric unlocking structure in an embodiment of the present disclosure;

FIG. 7 illustrates a schematic diagram of an assembled structure of an electric unlocking structure in an embodiment of the present disclosure;

FIG. 8 illustrates a schematic diagram of an exploded structure of an overall structure of an automobile fuel tank lock in an embodiment of the present disclosure;

FIG. 9 illustrates a schematic diagram of stereo structures in an embodiment of the present disclosure, after the base and the upper cover being mounted;

FIG. 10 illustrates a schematic diagram of a stereo structure of a guiding ring in an embodiment of the present disclosure;

FIG. 11 illustrates a schematic diagram of a stereo structure of a locating block in an embodiment of the present disclosure;

FIG. 12 illustrates a schematic diagram of a stereo structure of a guiding sleeve in an embodiment of the present disclosure;

FIG. 13 illustrates a schematic diagram of an internal structure of a guiding sleeve in an embodiment of the present disclosure;

FIG. 14 illustrates structures of some deep guiding grooves and shallow guiding grooves with a planar expansion view;

FIG. 15 illustrates a principle of a movement of a locating block between a deep guiding groove and a shallow guiding groove with a planar expansion view, wherein a locating rib is clamped under a bottom clamp stand of a shallow guiding groove;

FIG. 16 illustrates a principle of a movement of a locating block between a deep guiding groove and a shallow guiding groove with a planar expansion view, wherein a locating rib is pressed down, and just free of constraints of sides of the shallow guiding groove while not rotated;

FIG. 17 illustrates a principle of a movement of a locating block between a deep guiding groove and a shallow guiding groove with a planar expansion view, wherein a locating rib is pressed down, free of constraints of sides of the shallow guiding groove, and starts to be rotated;

FIG. 18 illustrates a principle of a movement of a locating block between a deep guiding groove and a shallow guiding groove with a planar expansion view, wherein a locating rib moves towards the deep guiding groove along a connection surface;

FIG. 19 illustrates a principle of a movement of a locating block between a deep guiding groove and a shallow guiding groove with a planar expansion view, wherein a locating rib is stably located in the deep guiding groove;

FIG. 20 illustrates a principle of a movement of a locating block between a deep guiding groove and a shallow guiding groove with a planar expansion view, wherein a locating rib is pressed down, and descends to a bottom of the deep guiding groove to be just free of constraints of sides of the deep guiding groove while not rotated;

FIG. 21 illustrates a principle of a movement of a locating block between a deep guiding groove and a shallow guiding groove with a planar expansion view, wherein a locating rib has been free of constraints of sides of the deep guiding groove and starts to be rotated;

FIG. 22 illustrates a principle of a movement of a locating block between a deep guiding groove and a shallow guiding groove with a planar expansion view, wherein a locating rib moves to a bottom of the shallow guiding groove along a connection surface.

### REFERENCE SIGNS

1: push rod; 2: motor; 3: guiding ring; 4: threaded rod; 5: locating block; 6: base; 7: guiding sleeve; 8: upper cover; 9: spring; 11: lock tongue; 13: cylindrical rod body; 17: first rotation guiding device; 30: flange; 31: first bevel; 32: second bevel; 35: tooth tip; 36: mounting hole; 37: tooth root; 55: column; 57: locating rib; 571: first locating rib bevel; 572: second locating rib bevel; 5715: top edge of first locating rib bevel; 59: clamp spring; 61: locating rod; 71: deep guiding groove; 73: shallow guiding groove; 710: connection surface; 713: side of deep guiding groove; 730: bottom clamp stand of shallow guiding groove; 733: side of shallow guiding groove; 7331: side; 7333: side; 77: rib; 80: transmission seat; 83: electric lock pin; 85: lock pin bayonet.

### DETAILED DESCRIPTION OF THE PREFERRED EMBODIMENTS

In order to more clearly understand the technical features, objectives and effects of the present disclosure, now the present disclosure is described with reference to the drawings.

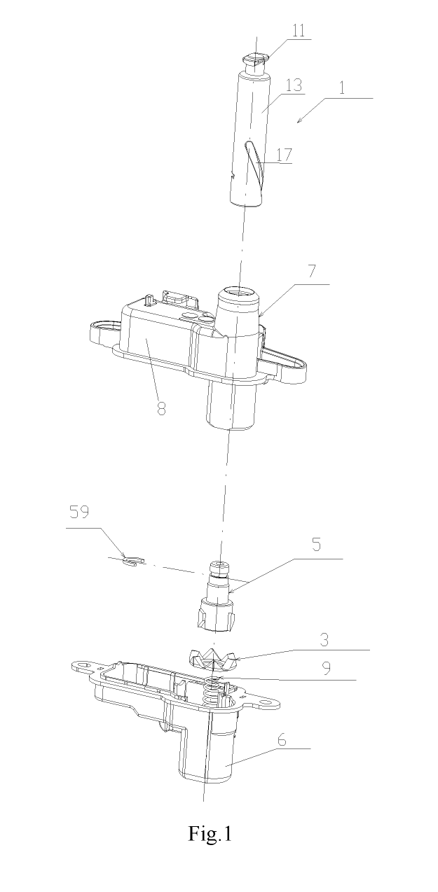

As illustrated in FIG. 1, the automobile fuel tank lock of the present disclosure comprises:

a manual unlocking structure that comprises:

a push rod 1, comprising: a cylindrical rod body 13, and a lock tongue 11 connected to a top of the cylindrical rod body; the lock tongue 11 may be pressed by a hand to cause the cylindrical rod body 13 to move downwards; during a downward movement, the lock tongue 11 can be rotated to lock an automobile fuel tank cap; the cylindrical rod body 13 is hollow, so as to be clamped with a locating block 5; further, a bottom of the cylindrical rod body 13 has a space for accommodating a top of a spring 9, so as to abut against the spring 9;

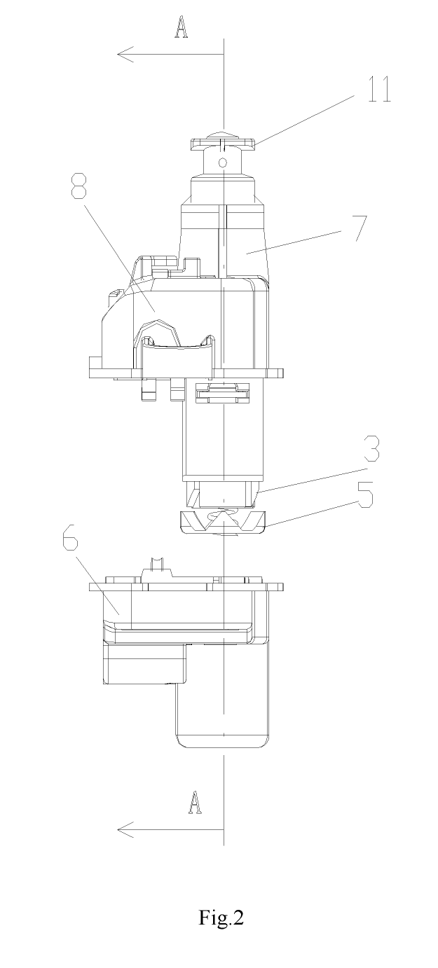

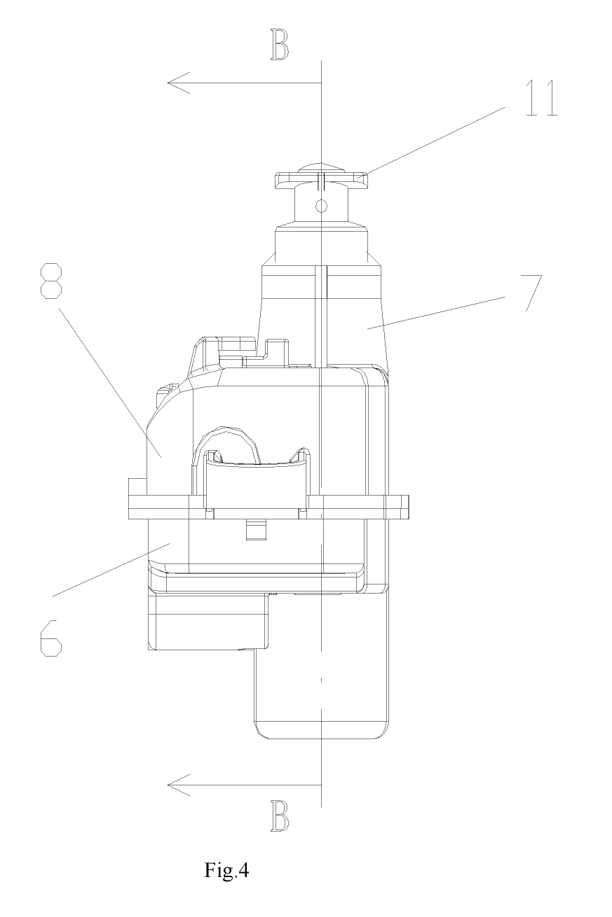

the locating block 5, as illustrated in FIGS. 2 to 5, clamped at the bottom of the cylindrical rod body 13 of tubular shape through a clamp spring 59; as illustrated in FIG. 11, the locating block 5 comprises a column 55 and locating ribs 57 provided to protrude from an outer side of the column; a top of each of the locating ribs 57 is provided with a first locating rib bevel 571 for locating by engaging with a clamp stand in a guiding sleeve 7; a bottom of each of the locating ribs 57 is provided with a second locating rib bevel 572 for engaging a toothed structure on a guiding ring 3; either of the first locating rib bevel 571 and the second locating rib bevel 572 forms an angle less than 90° with respect to a plane where a bottom edge of the column is located (e.g., a horizontal plane), such as 20°, and is used for pressing with the toothed structure on the guiding ring 3 to induce an axial motion or a circumferential motion;

the first locating rib bevel 571 and the second locating rib bevel 572 make the locating rib to be wedge-shaped; horizontal projections of the first locating rib bevel 571 and the second locating rib bevel 572 may be rectangular; both the first locating rib bevel 571 and the second locating rib bevel 572 are located above a top surface of the toothed guiding ring, wherein the second locating rib bevel 572 is located above the top surface of the toothed guiding ring so as to contact the top surface of the toothed guiding ring, and slide and rotate relative thereto;

the locating block has a first position and a second position; it may be defined that at the first position, a bottom of the second locating rib bevel 572 is located at the tooth tip 35, the locating rib 57 is located in the deep guiding groove, and the lock tongue is at a stretched position, which is an unlocked state (the lock tongue no longer clamps the fuel tank cap); at the second position, a top of the locating rib bevel is located at the tooth root 37, the locating rib 57 is detached from the deep guiding groove, and the lock tongue retracts, which is a locked state (the lock tongue clamps the fuel tank cap); of course, it is also possible to define or set an initial position of the locating rib 57, or set a stretched position or a retracted position of the lock tongue, so that the corresponding position of the locating rib 57 corresponds to the locked state or the unlocked state;

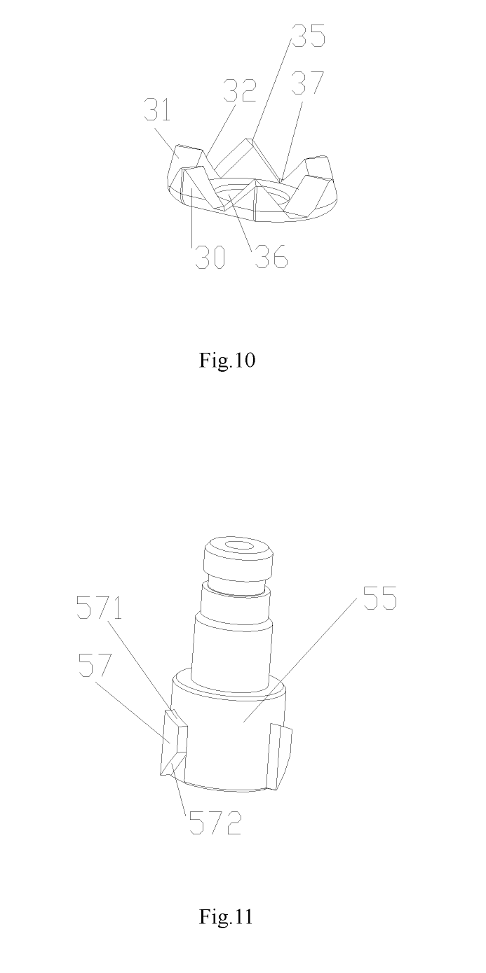

the guiding ring 3 provided at a bottom of the locating block 5; as illustrated in FIG. 10, a top surface of the guiding ring 3 is toothed, which can push the second locating rib bevel 572 obliquely or circumferentially when the locating block 5 is pressed down to the top surface of the guiding ring 3 along with the push rod 1, so that the locating block 5 can be rotated circumferentially when being pressed; the top surface of the guiding ring 3 is provided with tooth tips 35 and tooth roots 37; an outer side of the guiding ring 3 is provided with toothed flanges 30 which extend axially, and tops of the flanges 30 are provided with first bevels 31 and second bevels 32 which are alternatively arranged; the first bevels 31 crosses the second bevels 32 to form the top surface of the toothed guiding ring; the tooth tips are located at vertexes of the top surface of the toothed guiding ring, and the tooth roots are located at nadirs of the top surface of the toothed guiding ring; the tooth tips 35 and the tooth roots 37 are alternatively arranged to form a zigzag oblique plane or toothed plane in a circumferential direction of the guiding ring; the first bevel 31 and the second bevel 32 for example cross each other to form an obtuse angle such as 120°;

a base 6 for accommodating and supporting the guiding ring 3 which is fixed on the base 6 by clamping or in other manner;

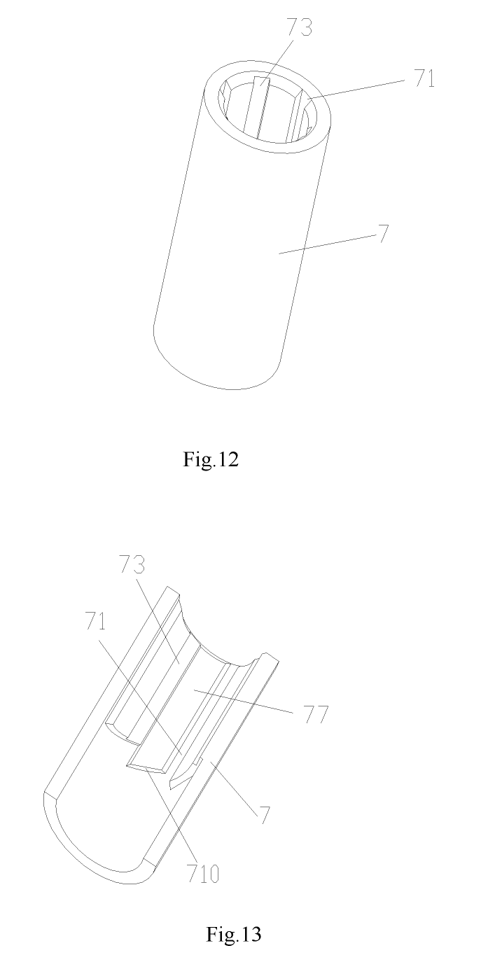

the guiding sleeve 7, as illustrated in FIGS. 12 and 13, for example is barrel-shaped and fixedly connected onto the base 6; the guiding sleeve 7 has a cavity and a sidewall surrounding the cavity, provides a sliding and rotating space for the locating block 5 and the push rod 1, and limits the locating block 5 and the push rod 1; the lock tongue 11 is always exposed outside the guiding sleeve 7 during the movement of the push rod 1; an inner sidewall of the guiding sleeve 7 is provided with deep guiding grooves 71 and shallow guiding grooves 73 which are alternatively arranged; and a depth of the deep guiding groove is larger than a depth the shallow guiding groove, so that the locating rib 57 can only slide in the deep guiding groove 71, rather than in the shallow guiding groove 73;

the cylindrical rod body 13 is rotatably provided in the cavity and can translate therein, and the lock tongue 11 is always exposed outside the guiding sleeve 7 during the movement of the cylindrical rod body 13; a height of the locating rib 57 is smaller than the depth of the deep guiding groove 71 while larger than the depth of the shallow guiding groove 73, the locating rib 57 can slide in the deep guiding groove 71, and a bottom of the shallow guiding groove 73 is provided with a bottom clamp stand 730 for limiting the locating rib 57;

the spring 9 provided on the base 6 and located between the locating block 5 and the guiding ring 3.

A top of the deep guiding groove is provided with a top clamp stand for limiting the top of the locating rib 57, the deep guiding groove further has a side 713, and the sides 713 of two deep guiding grooves form a sliding space for the locating rib 57.

The shallow guiding groove 73 consists of a side 733, a bottom clamp stand 730 and a top clamp stand; the side 733 of the shallow guiding groove comprises a side 7331 and a side 7333 parallel with each other; the bottom clamp stand 730 of the shallow guiding groove is used for limiting, and preventing the locating rib 57 from entering the shallow guiding groove from outside; specifically, the bottom clamp stand 730 of the shallow guiding groove is used to clamp the top surface of the locating rib 57, i.e., the first locating rib bevel 571, and prevents the movement of the locating rib 57. In order to stably clamp the first locating rib bevel 571, the bottom clamp stand 730 of the shallow guiding groove and the first locating rib bevel 571 have the same bevel shape or inclination. The side 7331 and the side 7333 are vertical sides. The guiding sleeve 7 is circular, and an inner wall thereof is totally provided with three deep guiding grooves and three shallow guiding grooves. The rib 77 separates adjacent deep guiding groove and shallow guiding groove from each other, or in other words, the rib 77 protruding from the inner wall of the guiding sleeve or an inner wall of a housing is provided between the deep guiding groove and the shallow guiding groove which are recessed in the inner wall of the guiding sleeve.

A connection surface 710 is provided between the adjacent deep guiding groove and shallow guiding groove, e.g., between the side 733 of the shallow guiding groove and the side 713 of the deep guiding groove adjacent to each other; the connection surface 710 is provided at the bottom of the rib 77 on the inner wall of the guiding sleeve or the inner wall of the upper cover 9; for example, each of the ribs 77 is provided with one connection surface 710, and the connection surfaces 710 are arranged in the same direction or inclination. The connection surface 710 for example guides the locating rib 57 from the below of the bottom clamp stand of the shallow guiding groove into the deep guiding groove 71, and also can guide the locating rib 57 from the deep guiding groove 71 to the below of the bottom clamp stand of the shallow guiding groove.

The connection surface 710 has a different height from the bottom clamp stand 730 of the shallow guiding groove at the left side, and they do not cross or connect each other, while the connection surface 710 is connected to the bottom clamp stand 730 of the shallow guiding groove at the right side; this arrangement is made so that the locating ribs 57 can orderly move out of the bottom clamp stand 730 of the shallow guiding groove in the same direction (e.g., clockwise or anticlockwise), then enter the deep guiding groove and leave therefrom to the below of the bottom clamp stand 730 of the shallow guiding groove, thus the locating ribs 57 can orderly move in and out in one direction to achieve a reciprocating circulation, which facilitates the operation.

The bottom of the deep guiding groove is provided with a connection surface 710, which is connected between the adjacent deep guiding groove 71 and shallow guiding groove 73; in this embodiment, there are three deep guiding grooves and three shallow guiding grooves, so there are totally six connection surfaces 710, and the bottom clamp stands 730 of the three shallow guiding grooves, which are arranged on the inner wall of the guiding sleeve or the inner wall of the upper cover in the same circumferentially extending direction, so as to change the locating rib 57 from a state of being located in the deep guiding groove to a state of being clamped on the bottom of the shallow guiding groove, and also make the locating rib 57 enter the deep guiding groove from the bottom of the shallow guiding groove through the connection surface 710, thereby achieving the continuous switching between locking and unlocking. Of course, in the process of each change of the position of the locating rib 57, the position of the first locating rib bevel 571 is also rotated.

Through the transition or engagement of the connection surface 710 of the deep guiding groove 71, the locating rib 57 can move into and out of the deep guiding groove 71, and can be clamped at the bottom of the shallow guiding groove 73 by the bottom clamp stand 730 of the shallow guiding groove 73 after being detached from the deep guiding groove 71, which forms ordinal switching between the movements into and out of the deep guiding groove 71, so that when the locating block 5 is pressed down next time, the locating rib 57 is pressed to externally enter the deep guiding groove 71 from the bottom of the bottom clamp stand 730 of the shallow guiding groove along the connection surface 710; during the switching, the rotation directions of the locating ribs 57 are the same, e.g., clockwise or anti-clockwise; wherein, the movement of the locating rib 57 into and out of the deep guiding groove may refer to related prior arts. For example, as illustrated in FIG. 20, the bottom clamp stands 730 are in the same direction, and the connection surfaces 710 are in the same direction. In addition, the extending directions of the bottom clamp stands 730 and the extending directions of the connection surfaces 710 are either clockwise or anti-clockwise.

During the operation, the lock tongue 11 is pressed down to cause the locating block 5 to be pressed onto the first bevel and the second bevel at the bottom of the guiding ring, the guiding ring applies an upward counterforce to the bottom of the locating rib 57, and in the pressing process the locating rib exits the bottom of the deep guiding groove 71; since the bottom of the locating rib has the second locating rib bevel 572 and the bottom of the guiding ring 3 is toothed, the bottom of the locating rib slides circumferentially after exiting the bottom of the deep guiding groove, thereby causing the locating block 5 to be rotated; under the action of the spring, the locating rib 57 is rotated, and clamped under the bottom clamp stand 730 of the shallow guiding groove along the connection surface 710 of the bottom of the deep guiding groove, while cannot move upwards, leftwards or rightwards, i.e., the locating rib 57 is stuck.

Meanwhile, in this process, the side of the cylindrical rod body is provided with a first rotation guiding device 17 through which the cylindrical rod body 13 is rotated, the lock tongue 11 is rotated when being pressed down to reach a stable unlocking position, thereby realizing unlocking. For example, when the locating block is at the first position, i.e., in a non-pressed state, the bottom of the second locating rib bevel is at the tooth tip, the locating rib 57 is in the deep guiding groove, and the lock tongue is at the stretched position, which is an unlocked state; when the locating block is at the second position, the bottom of the second locating rib bevel is at the tooth root, the locating rib 57 is detached from the deep guiding groove, and the lock tongue retracts, which is a locked state.

During the electric unlocking of the present disclosure, the unlocking of the fuel tank is achieved by further pressing down the lock tongue, thereby preventing the problem that the fuel tank cap is automatically opened by mistakenly pressing the fuel tank unlocking key.

When the lock tongue is pressed again after the locking, the top of the guiding ring 3 pushes the bottom of the locating rib 57; since the bottom of the locating rib has the second locating rib bevel 572, the locating block 5 is rotated; the locating rib 57 moves downwards from the bottom clamp stand 730 of the shallow guiding groove, reaches a next deep guiding groove 71 along a next adjacent connection surface 710, and enters the deep guiding groove 71 from the connection surface 710 under the action of the spring 9, thereby realizing an unlocking. In that case, even if the electric unlocking key is pressed, the lock tongue cannot be activated, thereby realizing locking. The connection surface 710 of the bottom of the deep guiding groove provides a transition surface or an engagement surface for the locating rib 57 to move into and out of the deep guiding groove 71.

In the processes of unlocking and locking, the applicant finds, after repeated researches, that the noise of the automobile fuel tank lock is mainly caused by the contact between the locating block and the guiding ring during unlocking or locking. Thus, the applicant further takes measures to reduce the hard contact between the locating block and the guiding ring while achieving the above unlocking convenience, or change the hard contact between the locating block and the guiding ring into a soft contact, i.e., provide a spring between the locating block and the guiding ring. On one hand, the spring functions to restore and support, so as to ensure smooth unlocking and locking. On the other hand, the spring has an elastic buffering function in the processes of unlocking and locking of the automobile fuel tank lock, so that the contact between the locating block and the guiding ring is achieved through an elastic buffering, and the contact between the locating block and the guiding ring is gentler and softer, which relieves the load exceeding a pressure required for a transmission between the locating block and the guiding ring, greatly decreases the huge impact between the locating block and the guiding ring, and largely reduces the noise of the automobile fuel tank lock in the processes of unlocking and locking to below 40 db.

Further, since the spring is provided between the locating block and the guiding ring, the contact between the locating block and the guiding ring is completed by an elastic buffering and becomes gentler and softer. The spring satisfies a necessary pressure between the locating block and the guiding ring, while relieving extra load and impact exceeding the necessary pressure, which greatly reduces the abrasion between the locating block and the guiding ring. In particular, during the traveling of the automobile, the spring can buffer the abrasions caused by various strenuous motions. Thus, the present disclosure prolongs the service lives of the locating block, the guiding ring, and then the automobile fuel tank lock.

Further, the deep guiding groove and the shallow guiding groove are separated from each other by the rib 77; the bottom of the rib is provided with a connection surface 710 which connects the deep guiding groove with the shallow guiding groove; the connection surface 710 have a first height difference between the vertex and the nadir thereof, and the connection surface 710 is a first bevel having the first height difference; the bottom clamp stand 730 of the shallow guiding groove has a limiting bottom surface; the limiting bottom surface have a second height difference between a vertex and a nadir thereof, and the limiting bottom surface is a second bevel having the second height difference; the height difference between the tooth tip 35 and the tooth root 37 is larger than either of the first height difference and the second height difference, so that the locating rib can enter or leave the deep guiding groove during the pressing process of the locating block.

Further, the push rod 1 also comprises a first rotation guiding device 17 located on a side of the cylindrical rod body 13, and the guiding sleeve 7 is provided with a second rotation guiding device for guiding the first rotation guiding device 17, so that the push rod 1 is rotatable during the pressing process of the push rod 1, thereby realizing a rotation of the lock tongue. The first rotation guiding device 17 for example is a spiral groove, and the second rotation guiding device is a guiding bump, which facilitates the manufacturing and mounting. Of course, the first rotation guiding device 17 may also be a guiding bump, and the second rotation guiding device is a guiding groove provided on the inner wall of the guiding sleeve.

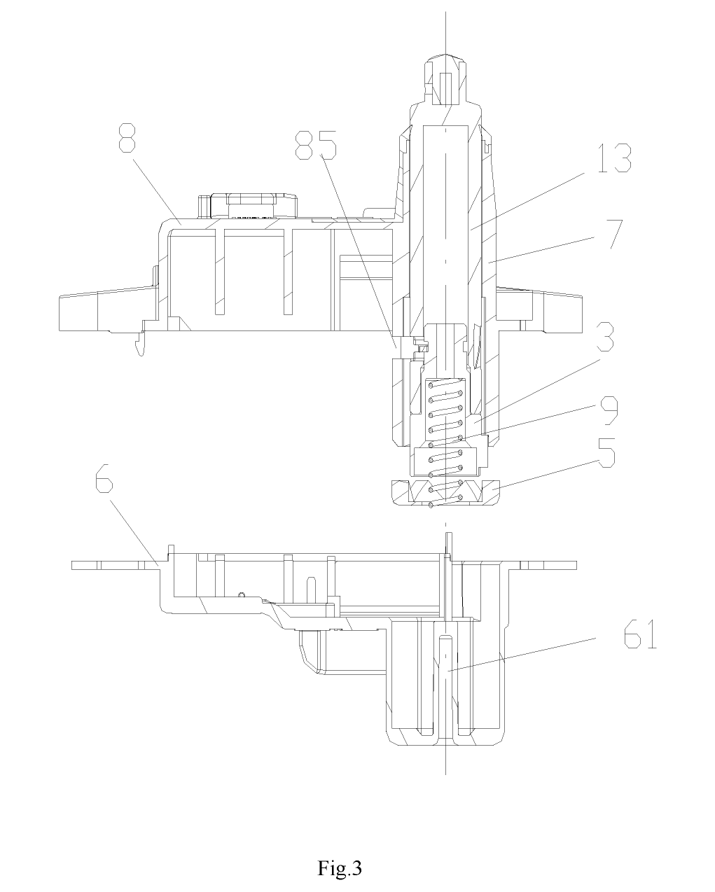

Further, as illustrated in FIGS. 3 and 5, the base 6 is provided with a locating rod 61 for mounting the spring 9, wherein the spring 9 and the guiding ring 3 are provided to sleeve the locating rod 61. The guiding ring 3 has a mounting hole 36, wherein the locating rod 61 passes through the mounting hole 36 and locates the spring 9 to ensure a stable position of the spring during the process of locking and unlocking, thereby ensuring stable locking and unlocking.

Further, the deep guiding groove and the shallow guiding groove are both straight grooves vertically arranged, wherein the number of the deep guiding grooves is three, the number of the shallow guiding grooves is three, and the number of the locating ribs is three. The deep guiding grooves 71 and the shallow guiding grooves 73 in the guiding sleeve may be totally six ones distributed uniformly in the circumferential direction at an interval of 60°. When the locating rib of the locating block enters the deep guiding groove 71, the lock tongue is in the stretched state, thereby realizing the unlocking action.

Further, the lengthwise direction of the locating rib is the axial direction of the column, the first locating rib bevel and the second locating rib bevel are rectangular, the extending direction of either of the first locating rib bevel and the second locating rib bevel is projected on a horizontal plane as the circumferential direction of the column, so as to form a stable fitting with the bottom surface of the toothed guiding ring.

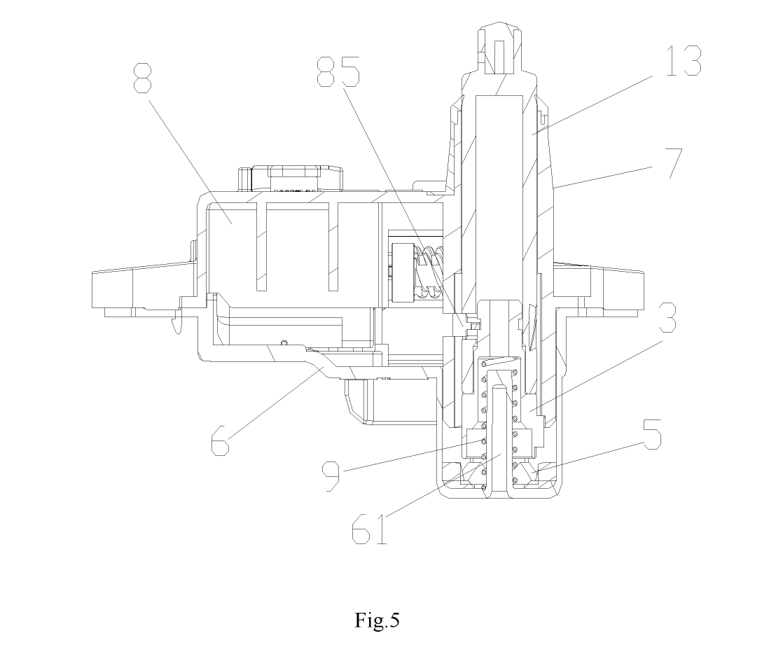

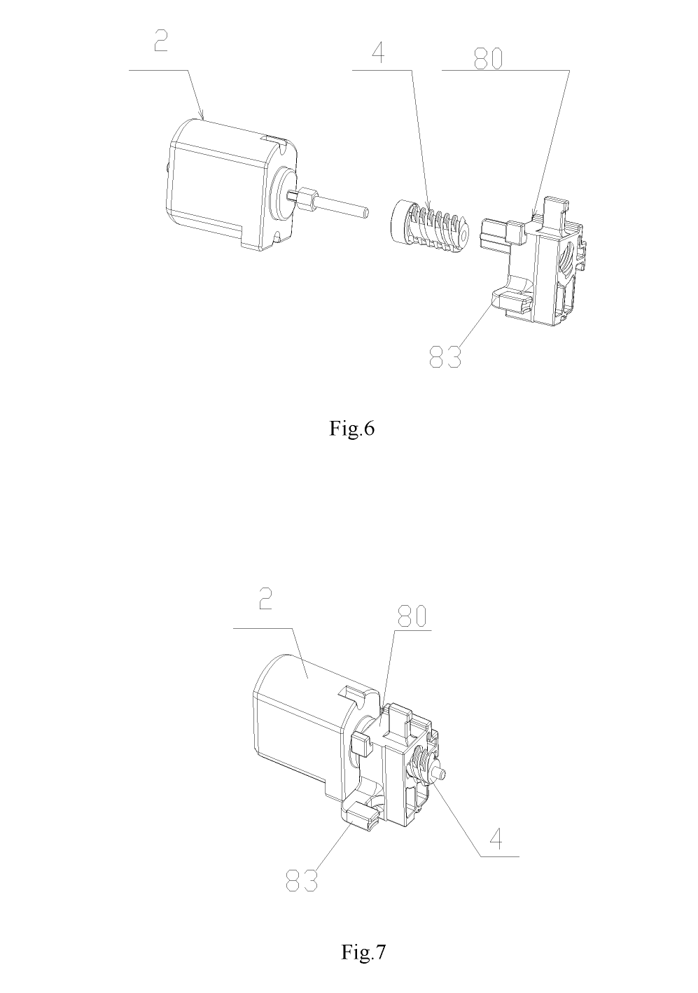

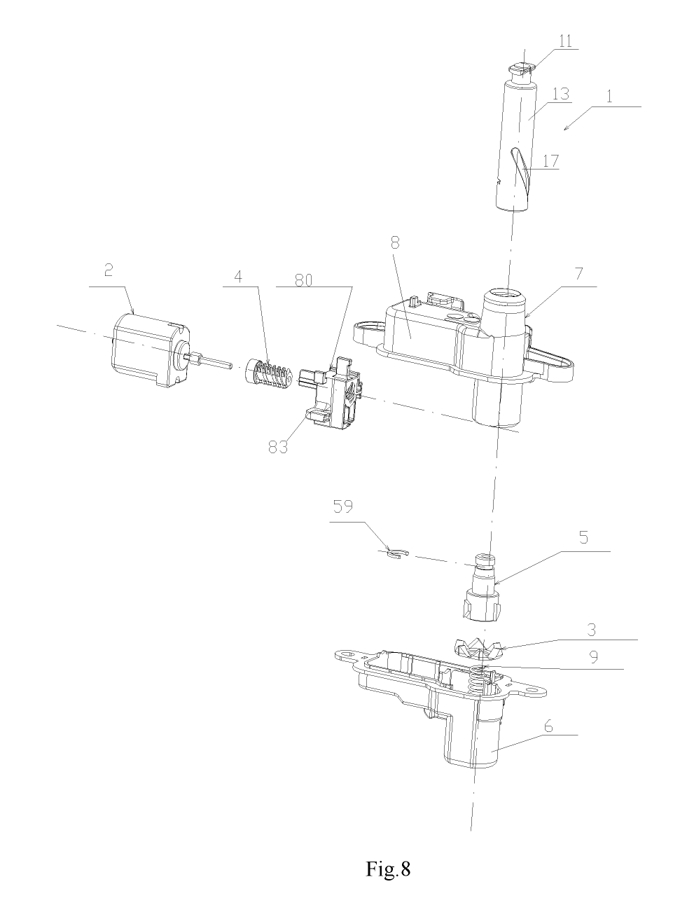

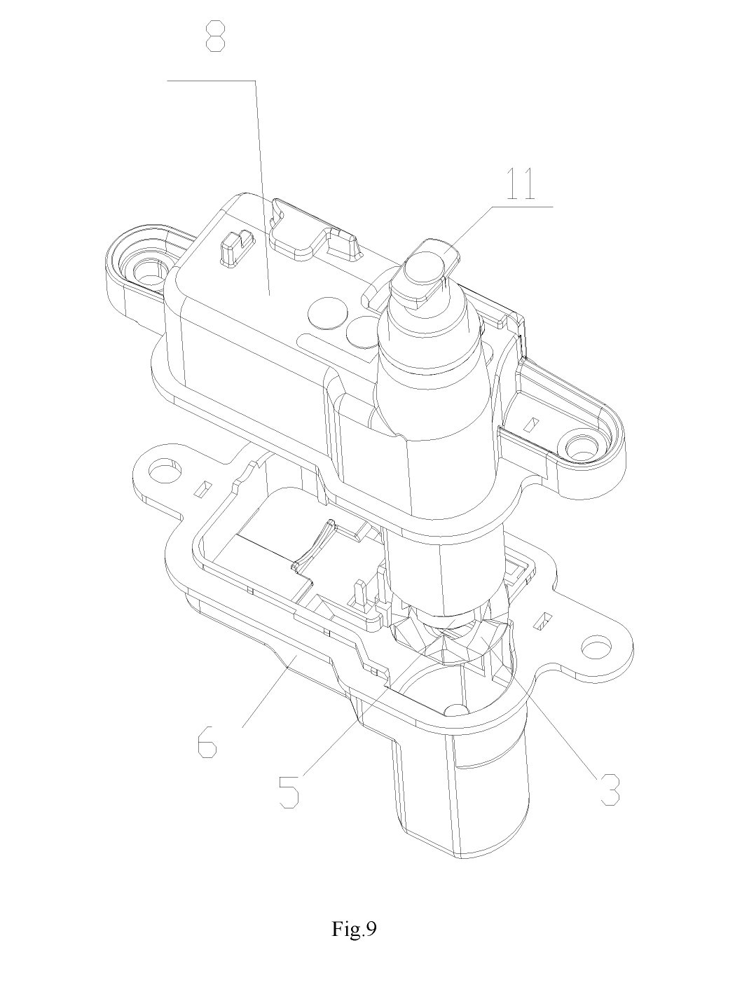

Further, as illustrated in FIGS. 6 to 9, the automobile fuel tank lock further comprises an electric unlocking structure which may be a supplementation or an auxiliary to the manual unlocking structure, and can improve the locking security based on the manual unlocking structure. The manual unlocking structure may be operated separately, or in conjunction with the electric unlocking structure.

The electric unlocking structure comprises:

a motor 2;

an electric lock pin 83 connected to the motor 2 (as illustrated in FIG. 7);

the lock pin bayonet 85 (as illustrated in FIGS. 3 and 5) is provided on the sidewall of the guiding sleeve, the electric lock pin is movable in the lock pin bayonet, and a moving direction of the electric lock pin is perpendicular to the axial direction of the cylindrical rod body; when the electric lock pin moves into the lock pin bayonet, the electric lock pin 83 limits the top of the column 55, i.e., when the electric lock pin 85 extends into the lock pin bayonet 85, it can be clamped at the top of the column 55 or the top of the locating block, so that the locating block 5 cannot move upwards or downwards, thereby realizing an electric locking.

In addition, the electric unlocking structure may further comprise a threaded rod 4 or a worm connected between the motor 2 and the electric lock pin 83, wherein the threaded rod 4 is connected to a transmission seat 80 on which the electric lock pin 83 is provided, and the transmission seat 80 translates under the spiral transmission of the threaded rod 4 to form a stable and uniform unlocking. The motor 2 may be controlled to be started and stopped. For example, the motor is connected to a controller in an automobile cab, and started and stopped under the command of the controller to cause the threaded rod 4 to be rotated, thus enabling the electric lock pin 83 to be clamped at the top of the column 55 or the top of the locating block when extending into the lock pin bayonet 85, so that the locating block cannot move upwards or downwards, thereby achieving an electric locking.

Further, the automobile fuel tank lock also comprises an upper cover 8 snap-fitted with the base 6 by a clamping; the base 6 and the upper cover 8 form a sealed space for mounting the motor 2, the electric lock pin 83, the push rod 1, the guiding ring 3, the locating block 5, the guiding sleeve 7 and the spring 9, so as to protect the manual unlocking structure and the electric unlocking structure, thereby achieving the effects of enclosing and protection. The guiding sleeve 7 may be mounted on an inner wall of the upper cover 8 as a separate part, or integrated with the upper cover 8, i.e., the inner wall of the upper cover is provided with deep guiding grooves and shallow guiding grooves for the convenience of wholistic machining. The upper-lower positions of the base 6 and the upper cover 8 are relative to each other, and during the usage, the base 6 may also be above the upper cover 8.

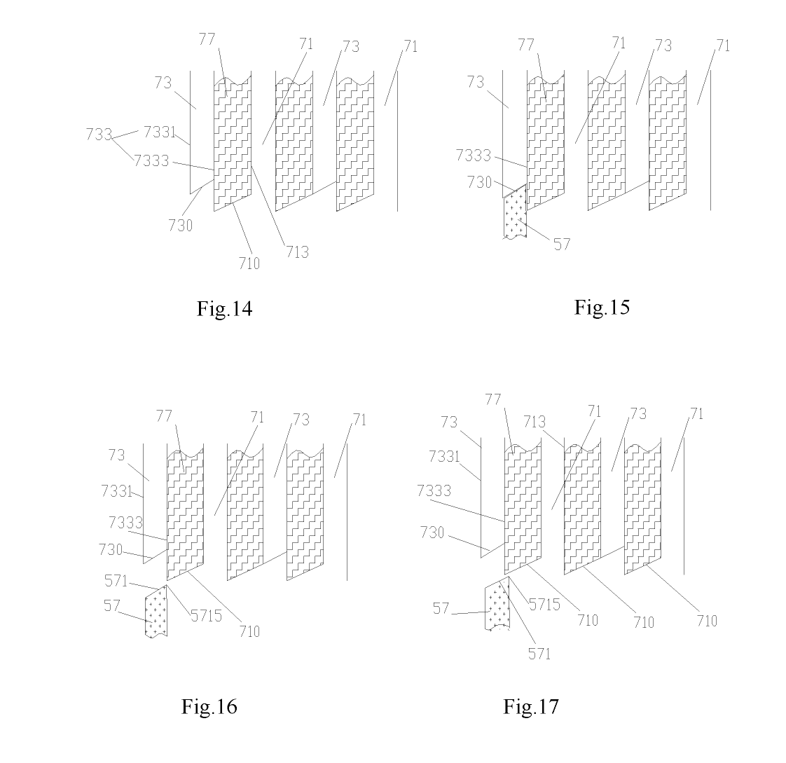

Next, the change process of the positional relation between the locating block 5 and the shallow guiding groove 73 and the deep guiding groove 71, when the manual unlocking structure is separately operated, will be described at first with reference to FIGS. 14 to 22:

In order to clearly describe the principle, FIGS. 14 to 22 stretch parts of a circular guiding sleeve or an upper cover onto a plane, illustrate some of the shallow guiding grooves 73 and the deep guiding grooves 71, and just illustrate an action of one locating rib 57 since the actions of other locating ribs 57 are synchronous with the illustrated action.

As illustrated in FIG. 14, the shallow guiding grooves 73 and the deep guiding grooves 71 are alternatively arranged on the inner wall of the guiding sleeve or the upper cover; the number of the shallow guiding grooves 73 and the number of the deep guiding grooves 71 are both three, and they are arranged annularly; the shallow guiding groove 73 and the deep guiding groove 71 are separated from each other by a rib 77 on the inner wall of the guiding sleeve or the upper cover. The shallow guiding groove 73 has two vertical sides, i.e., a side 7331 and a side 7333; a bottom of the shallow guiding groove 73 is provided with a bottom clamp stand 730 which is a bevel. The side 7331, the side 7333 and a portion above the bottom clamp stand 730 constitute the shallow guiding groove 73, which is a movement space for the guiding ring 3. The nadirs of the side 7331 and the side 7333 have different heights, e.g., the nadir of the side 7333 at the right is lower than that of the side 7331 at the left. The side 7333 and a portion below the bottom clamp stand 730 constitute a locating space for the locating rib 57, and the locating rib 57 cannot move upwards into the shallow guiding groove 73 under the constraint of the bottom clamp stand 730.

As illustrated in FIG. 15, it is an original state where the locating rib 57 is located below the bottom clamp stand 730 of the shallow guiding groove 73. The locating rib 57 is limited by the side 7333 at the right, while also limited by the bottom clamp stand 730 and under the action of the spring, thus it is stably located at the lower right to the bottom clamp stand 730.

As illustrated in FIG. 16, after being pressed down by the push rod 1, the locating block 5 is pressed obliquely by the guiding ring 3 (for example, via the tooth tips and tooth roots of the guiding ring 3), the locating rib 57 leaves the bottom clamp stand 730, and a top edge 5715 of the first locating rib bevel is located at the nadir of the side 7333 of the shallow guiding groove, just being free of the constraint of the side 7333 of the shallow guiding groove without being rotated yet.

As illustrated in FIG. 17, the locating block 5 is pressed down by the push rod 1, the locating rib 57 has been free of the constraint of the side 7333 of the shallow guiding groove, and the first locating rib bevel 571 is rotated circumferentially after being pressed down so that the top edge 5715 of the first locating rib bevel is rotated to a position lap jointed with the connection surface 710, or in other words, the projection of the top edge 5715 of the first locating rib bevel along the circumferential direction is lengthened so as to be connected to the connection surface 710.

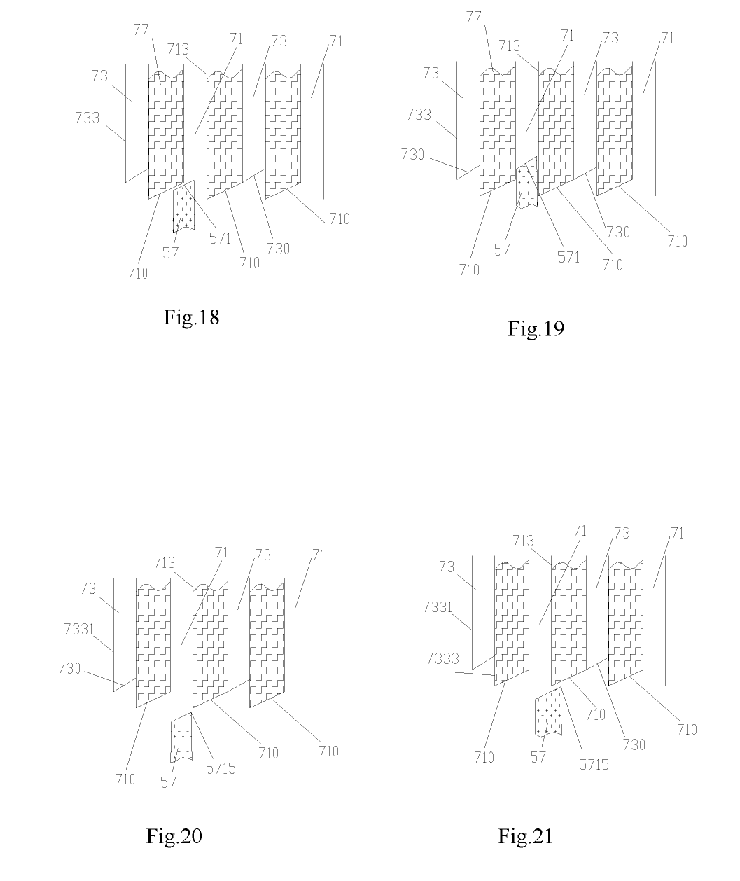

As illustrated in FIG. 18, under the actions of the first locating rib bevel 571 and the spring, the locating rib 57 gradually moves towards the deep guiding groove 71 along the connection surface 710. For example, during the moving process, the locating rib 57 continues to rotate to enter the deep guiding groove 71 at an appropriate circumferential angle.

As illustrated in FIG. 19, the locating rib has been stably located in the deep guiding groove along the connection surface 710, and the two sides of the locating rib 57 are limited by the side 713 of the deep guiding groove.

The above content is the process where the locating rib 57 is pressed down, exits the shallow guiding groove 73, and enters the deep guiding groove 71. Next, a process where the locating rib 57 exits the deep guiding groove 71 and enters the shallow guiding groove 73 will be introduced as follows.

As illustrated in FIG. 20, the locating rib is pressed down and descends to the bottom of the deep guiding groove, and the top edge 5715 of the first locating rib bevel reaches the nadir of the side 713 of the deep guiding groove, just being free of the constraint of the side 713 of the deep guiding groove without being rotated.

As illustrated in FIG. 21, since a connection surface 710 is always arranged between the adjacent deep guiding groove and shallow guiding groove, the extending directions of the connection surfaces 710 are the same; in addition, the connection surface 710 at the right side of the deep guiding groove 71 is directly connected to the shallow guiding groove 73 at the right side of the deep guiding groove 71; in that case, the locating rib has been free of the constraint of the side of the deep guiding groove and starts to be rotated; after being pressed down, the first locating rib bevel 571 rotates circumferentially so that the top edge 5715 of the locating rib bevel rotates to a position lap jointed with the connection surface 710, or in other words, the projection of the top edge 5715 of the locating rib bevel along the circumferential direction is lengthened so as to be connected to the connection surface 710.

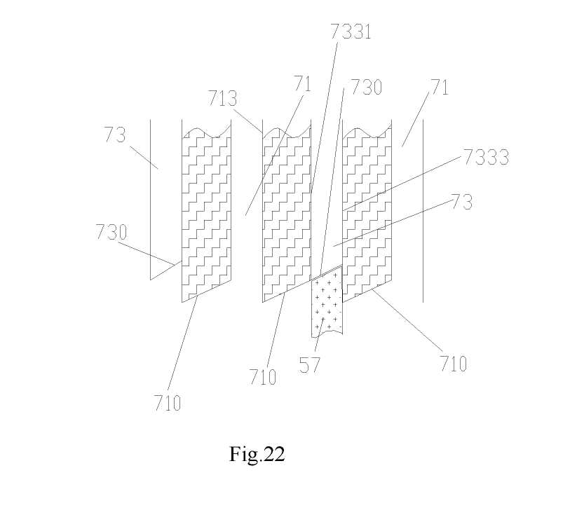

As illustrated in FIG. 22, under the action of the spring, the locating rib moves to the bottom of the shallow guiding groove along the connection surface 710, and located below the bottom clamp stand 730 of the shallow guiding groove. For example, in the moving process, the locating rib 57 continues to rotate to enter the bottom of the shallow guiding groove at an appropriate circumferential angle.

According to FIGS. 20 to 22, the locating rib 57 exits the deep guiding groove 71 and enters the bottom of the shallow guiding groove 73. Thus, the locating rib 57 returns to the original state, and realizes a cycle of moving into and out of the deep guiding groove and the shallow guiding groove, or realizes a cycle of unlocking and locking.

Through the coordinated actions of the push rod 1, the guiding ring 3, the locating block 5, the guiding sleeve 7 and the spring 9, the present disclosure realizes the extension, retraction and rotation, so as to perform unlocking and locking. The present disclosure can achieve the double insurance for the safe driving.

The push rod 1, the guiding ring 3, the locating block 5, the guiding sleeve 7 and/or the upper cover 8 of the present disclosure may be an injection-molded part or other workpiece. The injection mold can be manufactured easily, the injection molding production efficiency is improved, and the defective products are reduced, thereby realizing the product functions and meeting the customers' requirement. The injection-molded part has less abrasion and a longer service life due to the buffering function of the spring.

When the manual unlocking structure completes a locking together with the electric unlocking structure, the working process for example is as follows: 1. the motor is powered to cause the lock pin to exit; 2. at that time, the lock tongue is compressed downwards; 3. the locating rib 57 of the locating block is free of the constraints of the side of the shallow guiding groove 73 and the bottom clamp stand 730 of the shallow guiding groove 73, slides out of the deep guiding groove 71 through the connection surface 710, and rotates clockwise for about 20° under the actions of the first bevel and the second bevel of the guiding ring; under the action of the spring 9, the locating rib 57 of the locating block rotates in place (entering the deep guiding groove 71) to realize the positioning; 4. During this process, the lock tongue rotates for 90° and stretches out, which is the unlocking position.

In the locking state, the lock tongue is compressed downwards while rotating; the locating block is pressed down, and continue rotating clockwise for about 20° under the actions of the first bevel and the second bevel of the guiding ring; the locating rib 57 of the locating block rotates to the bottom of the next shallow guiding groove; at that time, the lock tongue retracts and rotates for 90°, which is the locking position.

The above descriptions just illustrate exemplary embodiment of the present disclosure, rather than limiting the scope of the present disclosure. In order that the constituent parts of the present disclosure can be combined with each other under the condition that there is no confliction, any equivalent change or amendment made by a person skilled in the art without deviating from the conception and principle of the present disclosure shall fall within the protection scope of the present disclosure.

1. An automobile fuel tank lock, comprising:
a manual unlocking structure that comprises:
a push rod, comprising a cylindrical rod body, and a lock tongue connected to a top of the cylindrical rod body;
a locating block connected to a bottom of the cylindrical rod body, comprising a column and locating ribs provided on an outer side of the column; a top of each of the locating ribs is provided with a first locating rib bevel; a bottom of each of the locating ribs is provided with a second locating rib bevel; either of the first locating rib bevel and the second locating rib bevel forms an angle less than 90° with respect to a plane where a bottom edge of the column is located;
a guiding ring provided at a bottom of the locating block, a top surface of the guiding ring being toothed and provided with tooth tips and tooth roots; the second locating rib bevel is located on the top surface of the toothed guiding ring, and slidable and rotatable relative thereto;
a base for accommodating and supporting the guiding ring;
a guiding sleeve fixedly connected onto the base, comprising a cavity and a sidewall surrounding the cavity; an inner sidewall of the guiding sleeve is provided with deep guiding grooves and shallow guiding grooves which are alternatively arranged, and a depth of the deep guiding groove is larger than a depth of the shallow guiding groove; the cylindrical rod body is rotatably provided in the cavity and can translate therein; a height of the locating rib is smaller than the depth of the deep guiding groove while larger than the depth of the shallow guiding groove; the locating rib can slide in the deep guiding groove; and a bottom of the shallow guiding groove is provided with a bottom clamp stand for limiting the locating rib;
a spring provided on the base, and located between the locating block and the guiding ring.

2. The automobile fuel tank lock according to claim 1, wherein the deep guiding groove and the shallow guiding groove are separated from each other by a rib; a bottom of the rib is provided with a connection surface which connects the deep guiding groove with the shallow guiding groove, and which is a first bevel having a first height difference; the bottom clamp stand of the shallow guiding groove has a limiting bottom surface which is a second bevel having a second height difference; a height difference between the tooth tip and the tooth root is larger than either of the first height difference and the second height difference.

3. The automobile fuel tank lock according to claim 1, wherein the push rod further comprises a first rotation guiding device located on a side of the cylindrical rod body, and the guiding sleeve is provided with a second rotation guiding device for guiding the first rotation guiding device.

4. The automobile fuel tank lock according to claim 1, wherein the base is provided with a locating rod for mounting the spring, and the spring and the guiding ring are provided to sleeve the locating rod.

5. The automobile fuel tank lock according to claim 1, wherein the deep guiding groove and the shallow guiding groove are both straight grooves vertically arranged; the number of the deep guiding grooves is three, the number of the shallow guiding grooves is three, and the number of the locating ribs is three.

6. The automobile fuel tank lock according to claim 1, wherein a lengthwise direction of the locating rib is an axial direction of the column, the first locating rib bevel and the second locating rib bevel are rectangular, and an extending direction of either of the first locating rib bevel and the second locating rib bevel is projected on a horizontal plane as a circumferential direction of the column.

7. The automobile fuel tank lock according to claim 1, further comprising an electric unlocking structure that comprises:
a motor;
an electric lock pin connected to the motor;
a lock pin bayonet provided on a sidewall of the guiding sleeve; the electric lock pin is movable in the lock pin bayonet, and a moving direction of the electric lock pin is perpendicular to an axial direction of the cylindrical rod body; when the electric lock pin moves into the lock pin bayonet, the electric lock pin limits a top of the column.

8. The automobile fuel tank lock according to claim 7, further comprising an upper cover snap-fitted with the base, and the base and the upper cover form a sealed space for mounting the motor, the electric lock pin, the push rod, the guiding ring, the locating block, the guiding sleeve and the spring.

9. The automobile fuel tank lock according to claim 7, wherein the electric unlocking structure further comprises a threaded rod connected between the motor and the electric lock pin.

10. The automobile fuel tank lock according to claim 3, wherein the first rotation guiding device is a spiral groove, and the second rotation guiding device is a guiding bump.
